(19) United States
(12) Patent Application Publication
(10) Pub. No.: US 2013/0096887 A1
(43) Pub. Date: Apr. 18, 2013

(54) Polymer Spring and Method for Designing Same

(71) Applicant: Ticona LLC, Florence, KY (US)

(72) Inventors: Jameson Fee, Rochester Hills, MI (US); Jill Higgins, Bloomfield Twp., MI (US)

(73) Assignee: TICONA LLC, Florence, KY (US)

(21) Appl. No.: 13/650,378

(22) Filed: Oct. 12, 2012

Related U.S. Application Data
(60) Provisional application No. 61/546,812, filed on Oct. 13, 2011.

(51) Int. Cl. F16F 1/36; G06F 19/00

(52) U.S. Cl. CPC F16F 1/3605; G06F 19/704
USPC 703/1; 267/153; 267/145

(57) ABSTRACT

Polymer springs are described having a closed cell geometry. The polymer springs are well adapted for replacing metal springs in various applications, such as in seat cushions. In one embodiment, the polymer springs include columns of closed cells, in which each cell has a curvilinear shape. A method for designing polymer springs is also described.

### RELATED APPLICATIONS

The present application claims priority to U.S. Provisional Application No. 61/546,812 filed Oct. 13, 2011, which is hereby incorporated by reference in its entirety.

### BACKGROUND

Springs are used in different types of applications and for various purposes. In the past, springs have typically been made from a metal, such as steel. Metallic springs, for instance, have been used in the manufacture of mattresses, chairs, upholstery, car seats, couches, and in various industrial applications as well.

Springs come in a variety of different sizes and configurations. For instance, many springs have a spiral or helical configuration. Spiral or helical springs posses high efficiency expressed in allowable energy absorption per pound of metal. Spiral or helical springs are also known to provide comfort when used in mattresses, chairs and other inclined devices. Spiral or helical springs, however, require a relatively large amount of volume when incorporated into a cushion.

In view of the above, other types of springs have also been developed including flat springs. Flat springs are generally two dimensional springs that are incorporated into cushions in an upright arrangement.

Although metal springs have good force displacement characteristics, the springs tend to be heavy and can add significant weight to the final product. In addition, metal springs over time have a tendency to rattle and make noise, especially when incorporated into seats made for vehicles. Further, metal springs have a tendency to corrode over time unless coated. This coating adds additional weight and cost.

In view of the above, a need exists for springs made from a polymer material. Polymer materials, for instance, are generally lighter and more corrosive resistant than many metals. Problems have been encountered, however, in designing polymers springs that not only have spring characteristics similar to metal springs, but also have sufficient fatigue and creep resistance for use in various applications, such as in chairs, mattresses and car seats. Thus, in the past, the ability to replace metal springs with polymer springs has met with limited success.

### SUMMARY

The present disclosure is generally directed to polymer springs for incorporating into numerous types of different products and applications. The present disclosure is also directed to a method for designing polymer springs, and particularly to a method of designing a polymer spring for replacing conventional metal springs. In one embodiment, the polymer spring of the present disclosure comprises a flat spring made from a plurality of closed cells that are contained in an interconnected grid. As will be described in greater detail below, the flat polymer spring can be designed so as to have a force displacement curve that is similar or equivalent to the force displacement curve of a metal spring.

In one embodiment, for instance, the present disclosure is directed to a polymer spring comprising a spring member made from a polymer material. For instance, the spring member can be metal free. The spring member comprises a network of interconnected closed cells. The cells are arranged in the network in columns that are configured to receive a compressive force. In one embodiment, the cells can be formed from rows of wave-like structural members. The wave-like structural members include valleys and peaks in an alternating arrangement. The wave-like structural members can be interconnected such that the peaks of one row are connected to the valleys of an adjacent row. In one embodiment, for instance, the peaks of one wave can be integral with the valleys of an adjacent row. The rows of wave-like structural members are connected together in a manner such that one column of cells formed from the structural members are offset and nested with an adjacent column of cells.

The polymer material used to form the spring can vary depending upon the particular application and the desired result. In one embodiment, for instance, the polymer material may comprise a polyoxymethylene polymer. In other embodiments, the polymer material may comprise polyamides including nylon 66, nylon 66/6, nylon 12, nylon 11, nylon 610, nylon 1010, nylon 612, nylon 46; polyphthalamide; thermoplastic ether-ester elastomer; thermoplastic polyether-ester elastomer; polybutylene terephthalate; polybutylene terephthalate alloys; cellulose acetate butyrate; cellulose acetate proprionate; thermoplastic vulcanizates; thermoplastic polyurethane elastomers including polyester-based and polyether-based elastomers; polymethyl methacrylate; polyurethane; acrylonitrile ethylene styrene; styrene butadiene styrene block copolymer; polymer alloys containing polyester based thermoplastic polyurethane elastomer polymers; polymer alloys containing acrylonitrile-butadiene styrene terpolymer and polyamide polymers; polymer alloys containing polyphenylene ether, polystyrene, and polypropylene polymers; polymer alloys containing polyphenylene ether, polystyrene, and nylon polymers; polymer alloys containing polyphenylene ether and polystyrene polymers; polymer alloys containing acrylonitrile styrene acrylate and polyamide polymers; polymer alloys containing polypropylene and ethylene propylene diene monomer rubber polymers; polymer alloys containing polyamide and polypropylene polymers; polymer alloys containing polyethylene terephthalate and polyamide (nylon 6) polymers. In one embodiment, a polymer material may be selected that has an elastic modulus from about 800 MPa to about 1500 MPa.

The size and shape of the closed cells in the polymer spring can also vary depending upon the particular application. In one embodiment, the closed cells are produced without the structural members having any straight lines or linear distances in order to minimize tensile stress and strain. The individual cells can have a height and a width and can have a height to width ratio from about 1:3 to about 1:20, such as from about 1:4 to about 1:10. In particular embodiments, the closed cells can have a curvilinear shape or an elliptical shape.

As described above, the polymer spring can be designed to have a particular force displacement curve. In one embodiment, the force displacement curve of the polymer spring at 200 mm/min can be such that the spring deflects from about 40 mm to about 20 mm at a load of 700 N. For instance, the spring may deflect from about 35 mm to about 25 mm at a load of 700N.

The polymer spring as described above is made from closed cells that are arranged in columns. In one embodiment, adjacent columns can be nested together such that two sides of one closed cell in one column form sides of adjacent cells in an adjacent column. In one embodiment, each column can contain from about 2 to about 5 cells in a stacked relationship.

The present disclosure is also directed to a method of designing a polymer spring. The method of the present disclosure can be used to design a spring as described above or can be used to design various other springs. For instance, the methods of the present disclosure can be used to design helical or spiral springs, other three dimensional springs, other flat springs, and generally any spring that has a closed cell structure.

In one embodiment, the method includes a step of first selecting a polymer material to form a spring. The spring is made from a plurality of closed cells. The polymer material selected can have an elastic modulus and a true stress verses true strain curve. In one embodiment, for instance, the true stress verses true strain curve may be determined based upon an engineering stress verses engineering strain curve.

The true stress verses true strain curve according to the present disclosure is converted into a true stress verses plastic strain curve. In one embodiment, the true stress verses plastic strain curve is normalized so that the curve is zero at an initial plastic strain.

Data regarding the true stress versus plastic strain curve is then inputted in to a computer simulation of the polymer spring. In addition to the true stress verses plastic strain curve, the tensile modulus and Poisson's ratio of the polymer material may also be inputted in to the computer simulation if desired. The computer simulation is configured to generate a force displacement curve based upon inputted cell dimensions and an inputted deflection distance. In one embodiment, for instance, the computer simulation may be configured to determine a force from about 2 to about 5 points along the deflection distance.

The generated force displacement curve can be compared to a desired force displacement curve. For example, in one embodiment, the force displacement curve generated by the computer simulation may be compared to a force displacement curve of a metal spring that the polymer spring is intended to replace. If necessary, the cell dimensions of the polymer spring can then be adjusted within the computer simulation until a desired force displacement result is obtained. The polymer spring can then be constructed based on the resulting cell dimensions. In one embodiment, in addition to determining a force displacement curve, the computer simulation may also output equivalent stress and maximum strain.

Other features and aspects of the present disclosure are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is one embodiment of a seat cushion that may be made in accordance with the present disclosure;

FIG. 2 is a perspective view of one embodiment of a polymer spring made in accordance with the present disclosure;

FIG. 3 is a perspective view of one cell contained in the polymer spring illustrated in FIG. 2;

FIG. 4 is a side view of the polymer spring illustrated in FIG. 2;

FIG. 5 is a side view of another embodiment of a polymer spring made in accordance with the present disclosure;

FIG. 6 is a graphical representation of force displacement curves for polymer springs similar to those illustrated in FIGS. 2 through 5; and

FIGS. 7 through 9 are graphical representations of the results obtained in the example below.

Repeat use of reference characters in the present specification and drawings is intended to mean the same or analogous elements.

### DEFINITIONS

The following are various definitions of terms used in the present specification.

A stress-strain curve as used herein is the relationship between stress and strain obtained while applying a load on a sample and determining the deformation of the sample. A stress verses strain curve typically includes an elastic region where stress is proportional to strain. A stress verses strain curve can also include a yield point after which further continuous stress results in permanent or inelastic deformation. A stress verses strain curve can also include a plastic region which is from the yield point until the cross-sectional area of the material starts decreasing. The stress verses strain curve can also include a region after the plastic region where the sample changes its length with a little or without any increase in stress until an ultimate stress point or fracture point is reached.

As used herein, “engineering strain” is the change in length divided by the original length of the specimen while “true strain” is the change in length divided by the instantaneous length integrated from the original length to the instantaneous length. The relationship between engineering strain and true strain is as follows:

true strain=ln(1+engineering strain)

As used herein, “engineering stress” is force divided by area as a body deforms. Engineering stress is determined with reference to the undeformed configuration of the sample meaning that engineering stress holds the cross-sectional area constant at its original value. As used herein “true stress” is stress based upon the instantaneous cross-sectional area of the specimen. The relationship between engineering stress and true stress is as follows:

true stress=engineering stress(1+engineering strain)^{(2×Poisson's ratio)}

As used herein, “tensile modulus” (1 mm/min), “tensile stress at yield” (50 mm/min), and “tensile strain at yield” (50 mm/min) are measured according to ISO Test 527-2/1A.

As used herein, “flexural modulus” (23° C.) is measured according to ISO Test 178.

As used herein “Poisson's ratio” of a material is the ratio of transverse contraction strain to longitudinal extension strain in the direction of a stretching force.

As used herein, “Charpy notched impact strength” is measured at

−30 C according to ISO Test 179/1eA.

As used herein, the “deflection temperature under load (DTUL)” is measured at 1.8 MPa according to ISO Test 75-1/-2.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a polymer spring made from a polymer material. The polymer spring includes a plurality of closed cells. In one embodiment, the closed cells can be formed from wave-like structural members made from the polymer material. The wave-like structural members are arranged in rows and adjacent rows are connected together to form the closed cells. The resulting spring includes closed cells that are arranged in interconnected columns that are particularly well designed to receive a compression force and provide a cushioning effect when compressed while “bouncing back” once the compression force is removed. In one embodiment, the polymer spring comprises a flat spring. In other embodiments, however, three dimensional springs can also be formed from the closed cell structure, such as cylindrical springs, and the like.

Another aspect of the present disclosure is directed to a method for designing a polymer spring. As will be described in greater detail below, the method is directed to selecting a particular polymer material and a spring construction. The spring construction, for instance, may be directed to a spring with closed cells. In accordance with the present disclosure, various stress and strain data of the polymer material is collected and/or determined. This information is then inputted into a computer simulation in order to generate a material card. In addition to a material card a three dimensional model of the spring is constructed in the computer simulation. The computer simulation is also capable of generating force displacement information regarding the spring. The dimensions of the spring, such as the dimensions of the closed cells, are then adjusted until a desired force displacement relationship is obtained. In one embodiment, for instance, the force displacement curve of the polymer spring being constructed is matched with the force displacement curve of another spring that is being replaced by the polymer spring. Once a desired force displacement relationship is obtained, the dimensions of the spring used to create the force displacement data is then used to produce the polymer spring.

Polymer springs made in accordance with the present disclosure can be used in numerous and different applications. The springs, for instance, may be used in mattresses, chairs, couches, other reclining devices, and the like. The springs can also be used in various industrial applications. Specifically, the springs of the present disclosure can be used in any application where an elastic device is needed that is capable of storing mechanical energy and where an element is needed that has specific force deflection properties.

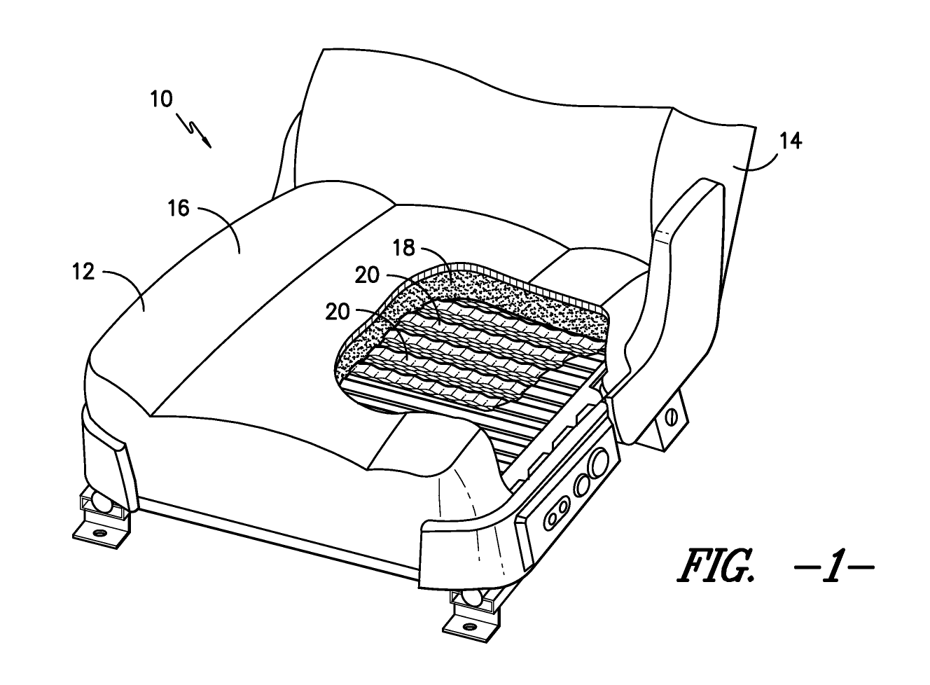

In one embodiment, for exemplary purposes only, the polymer spring of the present disclosure may be incorporated in to a seat cushion, such as a vehicle seat. Referring to FIG. 1, for instance, one embodiment of a vehicle seat 10 that may be made in accordance with the present disclosure is shown. The vehicle seat illustrated in FIG. 1 may be incorporated into a car, a truck, a van, or any suitable moving vehicle.

As shown, the seat 10 includes a seat cushion 12 and a backrest 14. The seat cushion 12 and the backrest 14 each include an outer covering 16.

As shown by the cut away portions, below the outer cover 16 is a cushion 18 that surrounds a plurality of springs 20 made in accordance with the present disclosure. The cushion 18 can be made from any suitable resilient material. For instant, the cushion 18 can comprise a foam, a batting, and mixtures thereof.

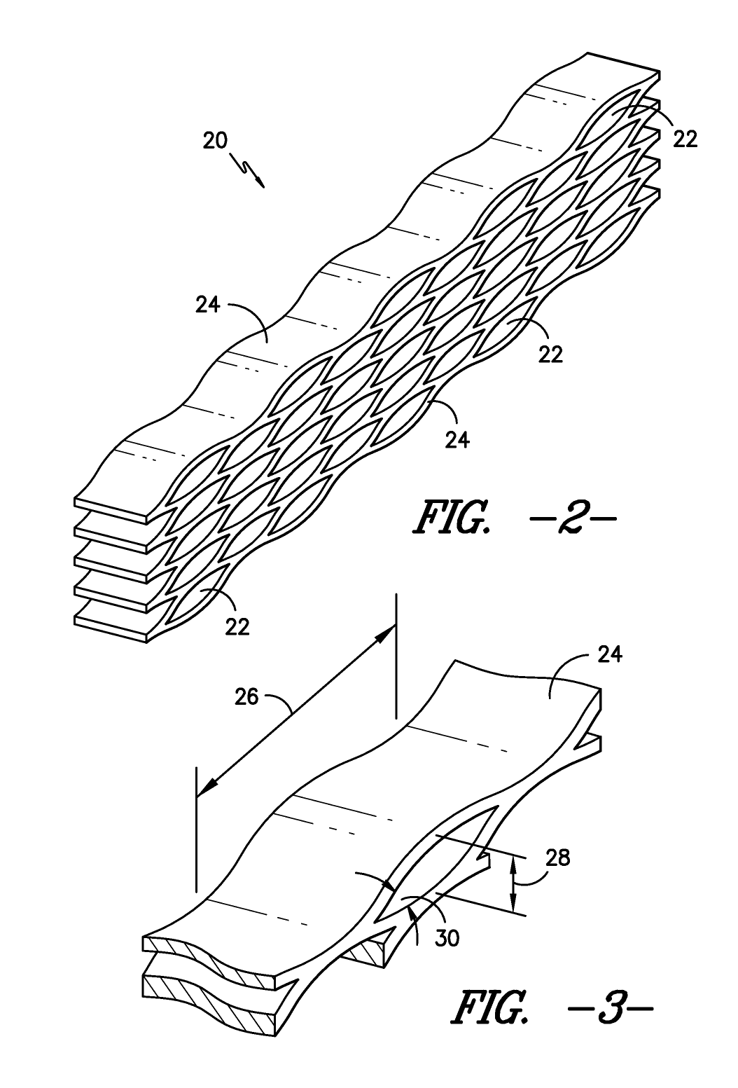

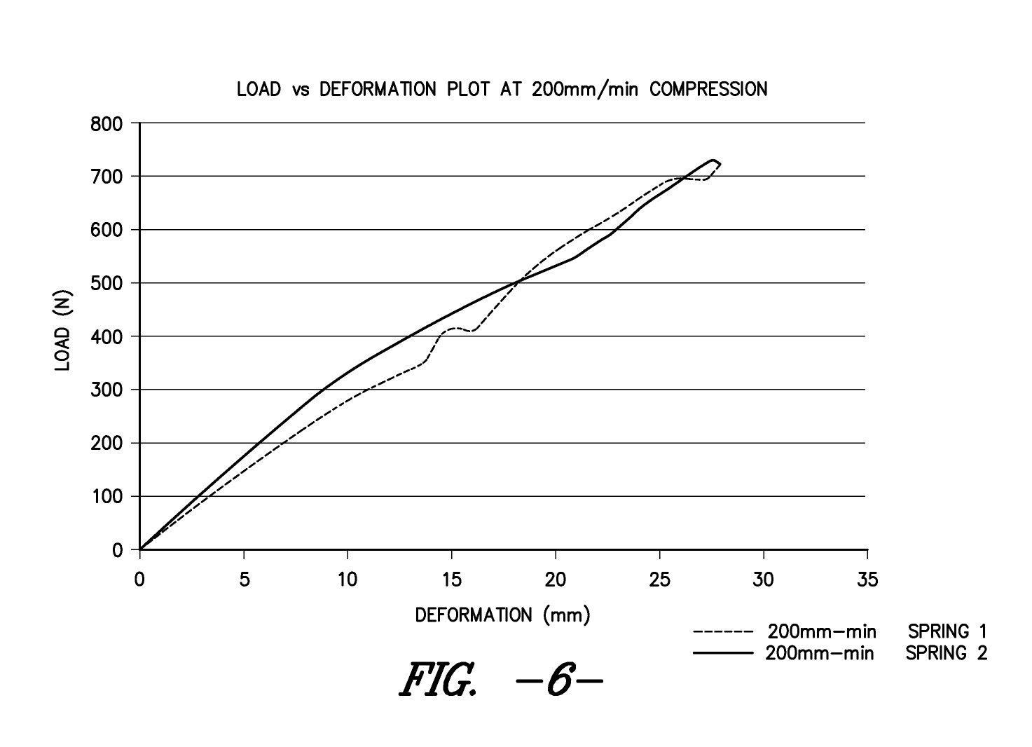

In accordance with the present disclosure, the vehicle seat 10 includes a plurality of polymer springs 20 that, in this embodiment, are spaced in rows from the back to the front of the seat. The polymer spring 20 is more particularly shown in FIGS. 2 through 4. As shown in the figures, the polymer spring 20 includes a plurality of closed cells 22. The closed cells 22 are arranged in columns.

As shown in FIG. 1, the columns of closed cells 22 of the polymer spring 20 are arranged in the seat cushion 12 such that the columns extend a direction from the bottom of the seat to the top of the seat. In the embodiment illustrated in FIG. 1, the polymer springs 20 are also arranged in rows that extend from the back of the seat to the front of the seat. The polymer springs, however, may be arranged in other directions such as from a side of the seat to the opposite side of the seat. In yet another embodiment, the polymer springs may be arranged in both a longitudinal direction of the seat and in a lateral direction of the seat.

The closed cells 22 provide the polymer spring 20 with cushioning characteristics and resiliency. In particular, the individual cells 22 allow the spring 20 to compress when subjected to a compression force in the direction of the columns, to store mechanical energy, and then to bounce back when the compressive force is removed. In this manner, the polymer springs provides a cushion support to a person resting on the seat 10.

In the embodiment illustrated in FIGS. 1 and 2, the polymer spring 20 comprises a flat spring in that the spring is primarily two dimensional in shape. In other embodiments, however, the spring 20 may contain closed cells but be in a three dimensional shape, such as in a helical shape. When designed as a flat spring as shown in FIG. 2, however, the polymer spring 20 has the ability to lay flat when not being used. For instance, in one embodiment, the seat 10 as shown in FIG. 1 may comprise a foldable seat in which the backrest 14 folds on top of the seat cushion 12. In order to further conserve space, the seat cushion 12 can be collapsible in that the polymer springs 20 may be contained in the seat cushion in a pivoting relationship such that the springs move from an upright configuration into a horizontal or flat configuration when the backrest 14 is folded onto the seat cushion 12.

As described above, the polymer springs 20 as shown in FIG. 2 generally comprises a network of closed cells 22 that are arranged in columns. In one embodiment, the closed cells 22 are formed from wave-like structural members 24 that are made from the polymer material. In the embodiment illustrated, the wave-like structural members are arranged in rows to form the network. The wave-like structural members are curved lines that include no linear portions. The wave-like structural members includes peaks and valleys. The rows of structural members 24 are connected such that the valleys of a top row are connected to (including integral with) the peaks of a bottom row.

In this manner, closed cells 22 are formed that have a curvilinear shape, such as an elliptical shape. The wave-like structural members also form interconnected columns of closed cells 22 in a manner such that one column of cells is offset and nested with an adjacent column of cells. As shown in FIG. 2, the sides of one cell are used to form the sides of adjacent cells. Because alternating columns of cells are in an offset relationship, in one embodiment, certain columns of cells may contain one cell more than an adjacent column. In the embodiment illustrated in FIG. 2, for instance, some columns contain four stacked cells, while alternating columns contain three cells.

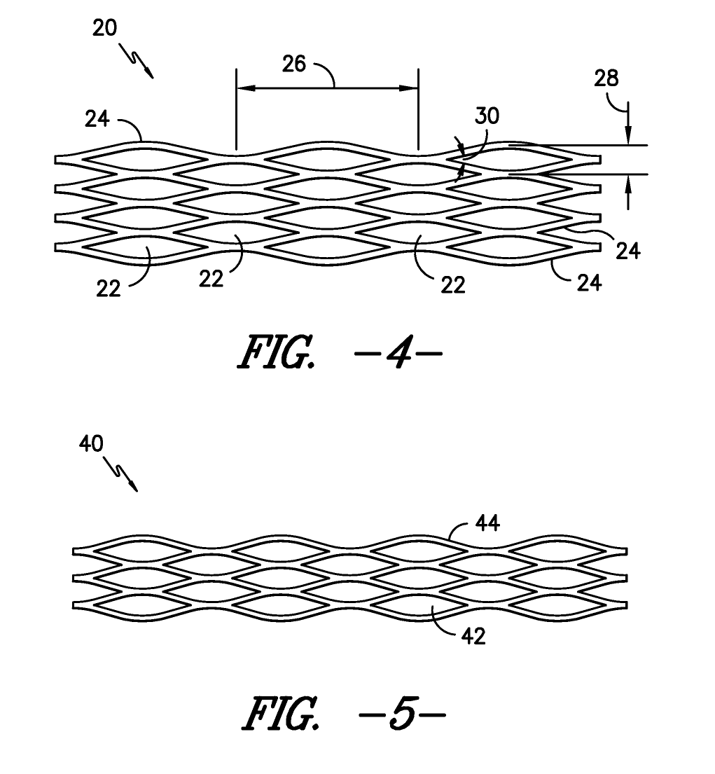

The closed cells 22 have a width 26 and a height 28 as shown particularly in FIG. 3. The wave-like structural members also intersect to form an angle 30 within each closed cell 22.

The width 26 and the height 28 can be adjusted such that the polymer spring 20 has a desired force displacement curve based upon the polymer material used to form the spring. In general, the closed cells 22 have a height to width ratio of from about 1:3 to about 1:20, such as from about 1:4 to about 1:10.

For exemplary purposes only, in one embodiment, for instance, the closed cells 22 may have a height to width ratio of from about 1:4 to about 1:5. For example, the height 28 of the closed cells 22 may be from about 5 mm to about 40 mm, such as from about 10 mm to about 20 mm, while the width 26 may be from about 20 mm to about 150 mm, such as from about 60 mm to about 80 mm. At the above dimensions, the depth of the polymer spring 20 may be from about 1 mm to about 10 mm, such as from about 2.5 mm to about 5 mm. In addition to the above, the closed cell can also have a beam thickness, which is the thickness of the wave-like structural members. The beam thickness, for instance, can be from about 0.5 mm to about 5 mm, such as from about 1.5 mm to about 3 mm in the embodiment described above. The actual dimensions, however, can vary widely depending upon the polymer material used and the end use application. The above dimensions are provided for exemplary purposes only.

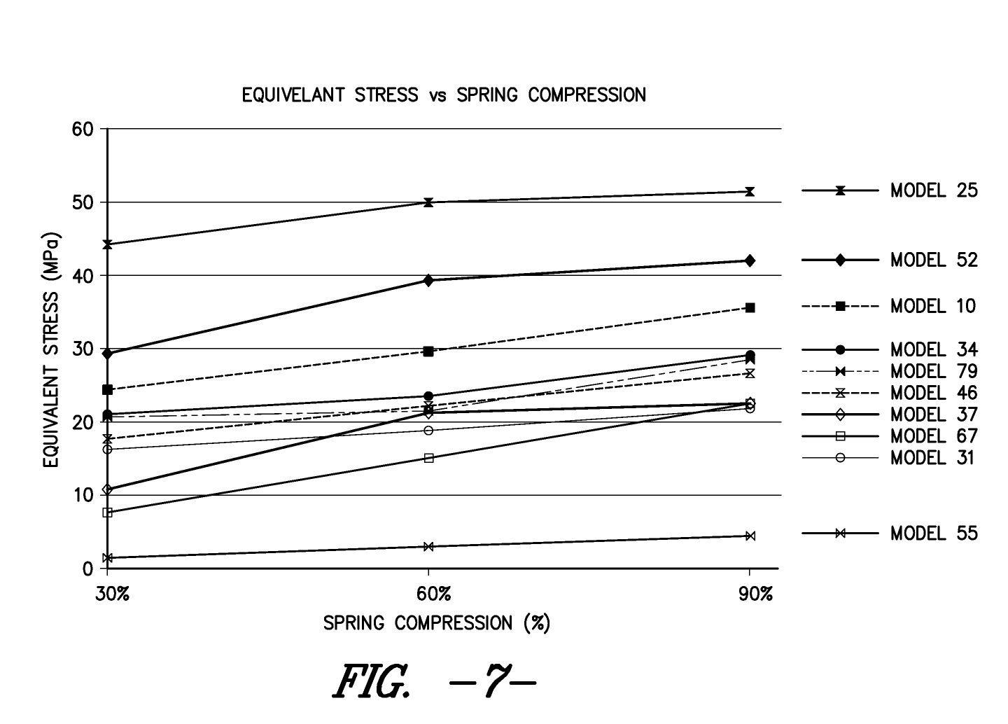

Referring to FIG. 5, another embodiment to a polymer spring 40 made in accordance with the present disclosure is shown. The polymer spring 40 includes closed cells 42 made from rows of wave-like structural members 44. The polymer spring 40 shown in FIG. 5 is very similar to the polymer spring 20 shown in FIG. 2. In FIG. 5, however, there are three closed cells in one column while there are two closed cells in an adjacent column. In accordance with the present disclosure, the polymer spring 40 as shown in FIG. 5 can be designed to have similar force displacement properties in comparison to the polymer spring 20 shown in FIG. 2.

The polymer material used to construct the polymer springs of the present disclosure can vary. When selecting a polymer material, the polymer material can have, in one embodiment, an elastic modulus in a desired range. For instance, in one embodiment, the elastic modulus of the polymer material used to form the spring can be from about 800 MPa to about 1500 MPa. In addition to elastic modulus, however, there are various other properties of the polymer that may be important. For instance, other properties to consider are the recovery, creep resistance, and flex fatigue properties of the material. The flex fatigue characteristics and the creep resistance of the material, for instance, may indicate how well the particular polymer material will perform over time. In some applications, it may also be desirable for the polymer material to be able to withstand various thermal cycles. For instance, if incorporated into a car seat, the polymer spring may be subjected to many thermal cycles over the life of the vehicle.

For example, the polymer material may have a tensile modulus of greater than about 800 MPa, such as greater than about 1000 MPa, such as greater than about 1200 MPa. The tensile modulus may be below about 3000 MPa. The tensile stress at yield for the polymer material may generally be greater than about 20 MPa, such as greater than about 25 MPa, such as greater than about 30 MPa, such as greater than about 35 MPa. The tensile stress at yield can be less than about 50 MPa. The tensile strain at yield is generally greater than about 10%, such as greater than 15%, such as greater than 20%, such as greater than about 25%. The tensile strain at yield can be less than about 40%.

The polymer material can also have desirable impact strength characteristics. For instance, the polymer material can have a Charpy notched impact strength of greater than about 8 kJ/m², such as greater than about

10 kJ/m², such as greater than about 12 kJ/m², such as greater than about

15 kJ/m². The Charpy notched impact strength for many materials is less than about 40 kJ/m². The polymer material can also have a DTUL at 1.8 MPa of greater than about 45° C., such as greater than about 50° C., such as greater than about 55° C., such as greater than about 60° C., such as greater than about 65° C. In general, the DTUL can be lower than about 150° C. The polymer material may have a level of crystallinity of greater than about 70%, such as greater than about 80%, such as greater than about 90%.

In one embodiment, the polymer material comprises a polyoxymethylene polymer. Polyoxymethylene polymers have excellent mechanical properties, fatigue resistance, abrasion resistance, chemical resistance, and moldability.

Polyoxymethylene polymers, which are also referred to as polyacethal polymers, may comprise a homopolymer or a copolymer and can include end caps. The homopolymers may be obtained by polymerizing formaldehyde or trioxane, which can be initiated cationically or anionically. The homopolymers can contain primarily oxymethylene units in the polymer chain. Polyacetal copolymers, on the other hand, may contain oxyalkylene units along side oxymethylene units. The oxyalkylene units may contain, for instance, from about 2 to about 8 carbon units and may be linear or branched. In one embodiment, the homopolymer or copolymer can have hydroxy end groups that have been chemically stabilized to resist degradation by esterification or by etherification.

As described above, the homopolymers are generally prepared by polymerizing formaldehyde or trioxane, preferably in the presence of suitable catalysts. Examples of particularly suitable catalysts are boron trifluoride and trifluoromethanesulfonic acid.

Polyoxymethylene copolymers can contain alongside the —CH2O— repeat units, up to 50 mol %, such as from 0.1 to 20 mol %, and in particular from 0.5 to 10 mol %, of repeat units of the following formula

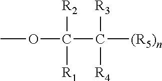

where R1 to R4, independently of one another, are a hydrogen atom, a C1-C4-alkyl group, or a halo-substituted alkyl group having from 1 to 4 carbon atoms, and R5 is —CH2-, —O—CH2-, or a C1-C4-alkyl- or C1-C4-haloalkyl-substituted methylene group, or a corresponding oxymethylene group, and n is from 0 to 3.

These groups may advantageously be introduced into the copolymers by the ring-opening of cyclic ethers. Preferred cyclic ethers are those of the formula

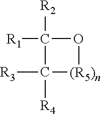

where R1 to R5 and n are as defined above.

Cyclic ethers which may be mentioned as examples are ethylene oxide, propylene 1,2-oxide, butylene 1,2-oxide, butylene 1,3-oxide, 1,3-dioxane, 1,3-dioxolane, and 1,3-dioxepan, and comonomers which may be mentioned as examples are linear oligo- or polyformals, such as polydioxolane or polydioxepan.

Use is also made of oxymethyleneterpolymers, for example those prepared by reacting trioxane with one of the abovementioned cyclic ethers and with a third monomer, preferably a bifunctional compound of the formula

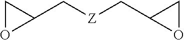

where Z is a chemical bond, —O— or —ORO—(R=C1-C8-alkylene or C2-C8-cycloalkylene).

Preferred monomers of this type are ethylene diglycide, diglycidyl ether, and diethers composed of glycidyl units and formaldehyde, dioxane, or trioxane in a molar ratio of 2:1, and also diethers composed of 2 mol of glycidyl compound and 1 mol of an aliphatic diol having from 2 to 8 carbon atoms, for example the diglycidyl ethers of ethylene glycol, 1,4-butanediol, 1,3-butanediol, 1,3-cyclobutanediol, 1,2-propanediol, or 1,4-cyclohexene diol, to mention just a few examples.

Polyacetal resins as defined herein can also include end capped resins. Such resins, for instance, can have pendant hydroxyl groups. Such polymers are described, for instance, in U.S. Pat. No. 5,043,398, which is incorporated herein by reference.

In one embodiment, the polyacetal polymer may contain hemiformal terminal groups and/or formyl terminal groups. In particular, it is believed that the methods of the present disclosure can advantageously significantly reduce formaldehyde emissions of polyacetal polymers, even when the polymers contain hemiformal terminal groups and possibly formyl terminal groups. For instance, in one embodiment, the polyacetal polymer may contain hemiformal terminal groups in amounts greater than 1.0 mmol/kg, such as in amounts greater than 1.5 mmol/kg. In an alternative embodiment, the polyacetal polymer may contain formyl terminal groups in amounts greater than 2 mmol/kg, such as in amounts greater than 2.5 mmol/kg.

The processes used to form the polyoxymethylene polymers as described above can vary depending upon the particular application. A process, however, can be used which results in a polyacetal resin having a relatively low formaldehyde content. In this regard, in one embodiment, the polymer can be made via a solution hydrolysis process as may be described in U.S. Patent Application Publication Number 2007/0027300 and/or in United States Patent Application Number 2008/0242800, which are both incorporated herein by reference. For instance, in one embodiment, a polyoxymethylene polymer containing aliphatic or cycloaliphatic diol units can be degraded via solution hydrolysis by using methanol and water with triolethylene.

Polyacetal resins or polyoxymethylenes that may be used in accordance with the present disclosure generally have a melting point of greater than about 150 degrees C. The molecular weight of the polymer can generally range from about 2,000 to about 1,000,000, such as from about 7,000 to about 150,000. The polymer can have a meltflow rate (MVR 190-2.16) from about 0.3 to about 20 g/10 min, and particularly from about 2 to about 9 g/10 min (ISO 1133).

In one embodiment, polyoxymethylene polymer may be used that contains a relatively high amount of reactive groups, such as hydroxyl groups in the terminal position. For instance the polyoxymethylene polymer can have terminal hydroxyl groups, such as hydroxyethylene groups, in at least more than about 50% of all the terminal sites on the polymer. For instance, the polyoxymethylene polymer may have at least about 70%, such as at least about 80%, such as at least about 85% of its terminal groups be hydroxyl groups, based on the total number of terminal groups present. It should be understood that the total number of terminal groups present includes all side terminal groups.

For instance, the polyoxymethylene polymer can have a content of terminal hydroxyl groups of at least 5 mmol/kg, such as at least 10 mmol/kg, such as at least 15 mmol/kg. In one embodiment, the terminal hydroxyl group content can range from about 18 to about 50 mmol/kg.

Other polymer materials that may be used to produce the polymer springs of the present disclosure include polyamides including polytetramethyleneadipamide, polyhexamethyleneadipamide, polyhexamethylenesebacamide, poly(11-aminoundecanoic acid), poly(12-aminododecanoic acid), hexamethyleneadipamide, polycaprolactam-co-dodecanediamide, and/or polydecamethylenesebacamide; polyphthalamide; thermoplastic ether-ester elastomer; thermoplastic polyether-ester elastomer; polybutylene terephthalate; polybutylene terephthalate alloys; cellulose acetate butyrate; cellulose acetate proprionate; thermoplastic vulcanizates; thermoplastic polyurethane elastomers including polyester-based and polyether-based elastomers; polymethyl methacrylate; polyurethane; acrylonitrile ethylene styrene; styrene butadiene styrene block copolymer; polymer alloys containing polyester based thermoplastic polyurethane elastomer polymers; polymer alloys containing acrylonitrile-butadiene styrene terpolymer and polyamide polymers; polymer alloys containing polyphenylene ether, polystyrene, and polypropylene polymers; polymer alloys containing polyphenylene ether, polystyrene, and nylon polymers; polymer alloys containing polyphenylene ether and polystyrene polymers; polymer alloys containing acrylonitrile styrene acrylate and polyamide polymers; polymer alloys containing polypropylene and ethylene propylene diene monomer rubber polymers; polymer alloys containing polyamide and polypropylene polymers; polymer alloys containing polyethylene terephthalate and polyamide (nylon 6) polymers.

In addition to the above polymers, the polymer composition used to form the spring can also contain various other components. In one embodiment, for instance, one of the above polymers may be combined with an impact modifier. For instance, in one embodiment, a polyoxymethylene polymer is used that is blended or chemically reacted with an impact modifier. The impact modifier may comprise, for instance, a thermoplastic elastomer. Thermoplastic elastomers include styrenic block of polymers, polyolefin blends referred to as thermoplastic olefin elastomers, thermoplastic polyurethanes that can be either polyester based or polyether based, thermoplastic copolyesters, and thermoplastic polyamides.

In one embodiment, a coupling agent may be present for coupling an impact modifier to the base polymer. The coupling agent, for instance, may comprise an isocyanate, such as a diisocyanate. For instance, the coupling agent may comprise 2,2′-, 2,4″-, or 4,4′-diphenylenethane diisocyanate or toluene diisocyanate.

The polymer composition used to produce the polymer spring may also contain various additives such as a formaldehyde scavenger, a light stabilizer, a filler, one or more lubricants, a coloring agent, an UV stabilizer, an acid scavenger, and the like.

As described above, one aspect of the present disclosure is directed to designing a polymer spring that will be suitable for use in a particular application. In designing a polymer spring in accordance with the present disclosure, a polymer material is first selected based on the properties of the polymer. For instance, a polymer material may be selected that not only has desired elastic modulus properties and a desired stress verses strain relationship, but that also has desired creep resistance properties, flex fatigue properties, and the like.

Once a polymer material is selected, information is collected regarding the stress verses strain relationship of the material. In one embodiment, for instance, the engineering stress verses engineering strain relationship of the polymer material can be collected or determined. The stress verses strain information can be obtained at any suitable rate, such as a rate of 200 mm/min.

Once the engineering stress and engineering strain information is collected, in accordance with the present disclosure, the data is then converted into true stress verses true strain information.

Once true stress and true strain data is calculated (if necessary) true strain is converted into plastic strain. The plastic strain of the material is where the stress verses strain is no longer linear. Thus, this information may be needed for the computer simulator.

In one embodiment, once the true stress verses plastic strain curve is obtained, the curve can be normalized such that the curve begins with a zero initial plastic strain.

The true stress verses plastic strain information obtained is then inputted into a computer simulation. A three dimensional model of the spring under design is also inputted into the computer simulation. For instance, in one embodiment, a 3D mechanical CAD (computer aided design) program may be used to create a 3D model of the spring that is then inputted into the computer simulation. The spring created may simply be one closed cell, may comprise one column of cells, or may comprise multiple columns of cells.

Various computer software is available for receiving the 3D model and receiving the true stress verses plastic strain information. For instance, in one embodiment, simulation software may be obtained from ANSYS, Inc. of Canonsburg, Pa.

Once the 3D model is inputted into the computer simulation, various material properties may be further inputted and contact conditions for the spring may be inputted. For instance, in one embodiment, simulations are conducted such that the spring is assumed to be connected to the top and bottom so that the spring stays in an upright position. In order to prevent the spring from intersecting with itself, the simulation may be run such that there is frictionless contact with itself and frictionless contact with outside surfaces wherever the spring is not attached to any adjacent structures.

In addition to the above contact conditions, various boundary conditions can also be assigned. For instance, a displacement can be applied to the top cells, such as up to about 90% of the gap. The simulation can also be run so that there is frictionless support on the front and back surfaces of the spring.

It should be understood that the contact conditions and the boundary conditions can vary depending upon the particular application and the ultimate end use of the spring.

Once the above information is inputted, the simulation is run. In one embodiment, the simulation is run so that a certain amount of deflection occurs on the spring. The computer simulation may then calculate forces on the spring based upon different points along the entire deflection. For example, in one embodiment, the computer simulation calculates force data from about 2 to about 5 different deflection distances. The computer simulation determines overall deformation and reaction force and thus can produce a force displacement curve for the spring model under consideration. In one embodiment, for instance, the computer simulation may determine equivalent stress, maximum principle strain, overall deformation, and reaction force.

The output received from the computer simulation is based upon the characteristics of the polymer material, the type of deflection exerted on the spring, and the dimensions of the spring. Once a force displacement curve is obtained, the result can be compared to a desired force displacement curve. In one embodiment, the cell dimensions of the spring can then be varied until a desired force displacement result is obtained. Once the desired result is obtained, the dimensions inputted into the computer simulation for the spring can be used to produce the spring from the polymer material.

In one embodiment, for instance, the spring design method may be used to replace a metal spring. In this embodiment, for instance, a force displacement curve for the metal spring may be determined or otherwise obtained. The dimensions of the closed cell structures for the polymer spring may then be varied until the force displacement curve for the polymer spring matches or approximates the force displacement for the metal spring. In this manner, a polymer spring can be designed for replacing metal springs.

The method of the present disclosure may also be used to design polymer springs that exhibit a desired strain limit at a particular compression. For instance, in one embodiment, a spring can be designed such that the spring exhibits no greater than about 2.5% strain at full compression. For instance, the spring can be designed such that it exhibits no greater than about 2.25% strain, such as no greater than about 2% strain, such as no greater than about 1.75% strain at full compression. Full compression is the design compression limit for the spring. For instance, under full compression, the spring may be compressed greater than 30%, greater than 40%, greater than 50%, greater than 60%, greater than 70%, and possibly even greater than 80% depending upon the particular application.

The present disclosure may be better understood with reference to the following examples.

### EXAMPLES

In the following examples, various polymer spring constructions were designed and force displacement data was generated using a computer simulation. The computer simulation was based upon constructing the polymer springs from a polyoxymethylene copolymer. The a polyoxymethylene polymer has a density of 1.33 g/cc, has a tensile strength of about 35 MPa, an elongation at yield of about 25%, a tensile modulus of about 1.2 GPa, and a flexural modulus of about 1.1 GPa.

Engineering stress verses engineering strain data was obtained for the polyoxymethylene polymer. The stress verses strain data was obtained at

23° C., at a rate of 200 mm/min and at ν=to 0.44.

In obtaining force displacement curves for the polymer spring models, the following process was used.
1. Convert engineering stress verses engineering strain data to true stress verses true strain data.
2. Convert true stress verses true strain data into true stress verses plastic strain data. In particular, the true stress verses plastic strain data is normalized or reduced to 15 to 18 points.
3. Create a solid model of the polymer spring using SOLIDWORKS software, which is a three dimensional mechanical computer aided design (CAD) program. For speed of modeling and to insure the model converges to a solution, initial models are of one cell or one column of cells. Since the model springs are symmetric, the results can be scaled to a full matrix. Only splines are used to model the cells to eliminate straight sections.
4. Computer simulation is conducted on ANSYS MECHANICAL simulation software. Initially, a multi-linear isotropic hardening material model file is created by inputting the true stress verses plastic strain data and the tensile modulus and Poisson's ratio.
5. The three dimensional spring model is imported into the ANSYS MECHANICAL simulation software and material properties are assigned to the model. The non-linear material effects are activated in the software.
6. Contact conditions are assigned in the ANSYS MECHANICAL simulation software. The contact positions are as follows:
   a) Assume the top and bottom most section of the column of cells of the spring is bonded to the top and bottom surface.
   b) Add frictionless contact of the spring with itself to prevent the spring from intersecting with itself when fully compressed.
   c) Add frictionless contact on outside surfaces where not bonded.
7. Boundary conditions are then assigned. The following boundary conditions were used.
   a) Applied displacement on top cells (up to 90% of gap).
   b) The bottom of spring is fixed.
   c) Frictionless support is assigned on the front and back surfaces of the spring.
8. The ANSYS MECHANICAL simulation software is inputted with settings for analysis. The following settings are used.
   a) Turn on large deflection.
   b) Set up three sub steps at 30% of the total deflection in order to get loads at each step. Loads are obtained at 30%, 60% and 90%.
   c) Configure software to output equivalent stress, maximum principle strain, overall deformation, and reaction force.
9. The computer simulation is then run to obtain the above outputs.
10. If the obtained reaction force at the fully compressed distance is similar to a desired result, then force deflection curves are plotted using the reaction forces and the deflections obtained from the simulation. The obtained force detection curve may then be compared with a desired force deflection curve.
11. If a desired reaction force or force deflection curve is not obtained, the cell design within the spring may be adjusted and the above process may be repeated.

### Example 1

The procedure above was used to obtain force deflection curves for polymer springs similar to the springs illustrated in FIGS. 2 and 5.

For the polymer spring illustrated in FIG. 2, the following spring dimensions were used:

Spring 1 Array
Height=45.776 mm
Width=207.8106 mm
Depth=3.2 mm
Beam thickness=2.0 mm
Cell Width=70 mm
Cell Height=15 mm

For the spring illustrated in FIG. 5, the following spring dimensions were inputted.

Spring 2 Array
Height=45.776 mm
Width=275.8735 mm
Depth=3.2 mm
Beam thickness=2.0 mm
Cell Width=70 mm
Cell Height=15 mm

For purposes of comparison, the force deflection of a metal spring was obtained. The above spring arrays were configured so that each spring intersected the force displacement curve of the metal spring at a load of 700N.

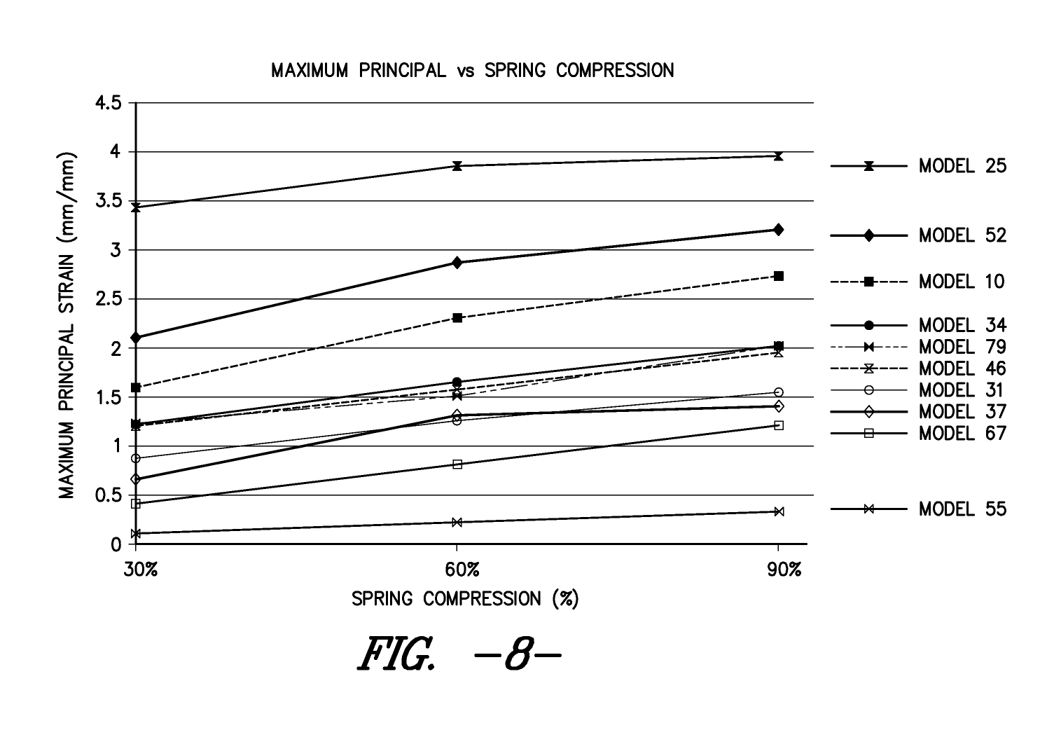

As shown in FIG. 6, the polymer springs deflect from about 40 mm to about 20 mm at a load of 700N and particularly deflect from about 35 mm to about 25 mm at a load of 700N.

### Example 2

The dimensions of a single cell in a polymer spring, such as the one illustrated in FIG. 2, was varied while undergoing the computer simulation method described above. In particular, various spring models were tested in which the dimensions of the closed cells where changed. The following results were obtained. In the table below, simulations were run for Model Nos. 1-4, 7, 10, 13, 16, 19, 22, 25, 28, 31, 34, 37, 40, 43, 46, 49, 52, 55, 58, 61, 64, 67, 70, 73, 76, and 79. Data regarding the remaining model numbers was extrapolated from the simulations.

| | Dimensions | | | | | | | |
|---|---|---|---|---|---|---|---|---|
| | Cell | Cell | Beam | Cell | 30% | | | |
| | Width | Height | Thickness | Depth | Deformation | Equivalent | Max Prin | Force |
| | (mm) | (MM) | (mm) | (mm) | [mm] | Stress [MPa] | Strain | Reaction [N] |
| Model 1 | 35 | 7.5 | 1 | 1.6 | 1.951 | 20.647 | 1.4069 | 1.7256 |
| Model 2 | 35 | 7.5 | 1 | 3.2 | 1.951 | 20.647 | 1.4069 | 3.4512 |
| Model 3 | 35 | 7.5 | 1 | 6.4 | 1.951 | 20.647 | 1.4069 | 6.9024 |
| Model 4 | 35 | 7.5 | 2 | 1.6 | 1.6541 | 23.518 | 1.6665 | 12.901 |
| Model 5 | 35 | 7.5 | 2 | 3.2 | 1.6541 | 23.518 | 1.6665 | 25.802 |
| Model 6 | 35 | 7.5 | 2 | 6.4 | 1.6541 | 23.518 | 1.6665 | 51.604 |
| Model 7 | 35 | 7.5 | 3 | 1.6 | 1.355 | 29.273 | 2.1799 | 39.476 |
| Model 8 | 35 | 7.5 | 3 | 3.2 | 1.355 | 29.273 | 2.1799 | 78.952 |
| Model 9 | 35 | 7.5 | 3 | 6.4 | 1.355 | 29.273 | 2.1799 | 157.904 |
| Model 10 | 35 | 15 | 1 | 1.6 | 4.2016 | 24.428 | 1.5939 | 2.3006 |
| Model 11 | 35 | 15 | 1 | 3.2 | 4.2016 | 24.428 | 1.5939 | 4.6012 |
| Model 12 | 35 | 15 | 1 | 6.4 | 4.2016 | 24.428 | 1.5939 | 9.2024 |
| Model 13 | 35 | 15 | 2 | 1.6 | 4.6906 | 30.737 | 2.3081 | 14.503 |
| Model 14 | 35 | 15 | 2 | 3.2 | 4.6906 | 30.737 | 2.3081 | 29.006 |
| Model 15 | 35 | 15 | 2 | 6.4 | 4.6906 | 30.737 | 2.3081 | 58.012 |
| Model 16 | 35 | 15 | 3 | 1.6 | 3.6216 | 37.489 | 2.9254 | 41.08 |
| Model 17 | 35 | 15 | 3 | 3.2 | 3.6216 | 37.489 | 2.9254 | 82.16 |
| Model 18 | 35 | 15 | 3 | 6.4 | 3.6216 | 37.489 | 2.9254 | 164.32 |
| Model 19 | 35 | 30 | 1 | 1.6 | 8.7019 | 26.952 | 2.0408 | 2.397 |
| Model 20 | 35 | 30 | 1 | 3.2 | 8.7019 | 26.952 | 2.0408 | 4.794 |
| Model 21 | 35 | 30 | 1 | 6.4 | 8.7019 | 26.952 | 2.0408 | 9.588 |
| Model 22 | 35 | 30 | 2 | 1.6 | 8.4188 | 37.036 | 2.8729 | 13.93 |
| Model 23 | 35 | 30 | 2 | 3.2 | 8.4188 | 37.036 | 2.8729 | 27.86 |
| Model 24 | 35 | 30 | 2 | 6.4 | 8.4188 | 37.036 | 2.8729 | 55.72 |
| Model 25 | 35 | 30 | 3 | 1.6 | 8.1529 | 44.18 | 3.4347 | 37.783 |
| Model 26 | 35 | 30 | 3 | 3.2 | 8.1529 | 44.18 | 3.4347 | 75.566 |
| Model 27 | 35 | 30 | 3 | 6.4 | 8.1529 | 44.18 | 3.4347 | 151.132 |
| Model 28 | 70 | 7.5 | 1 | 1.6 | 1.9503 | 6.1087 | 0.3979 | 0.2289 |
| Model 29 | 70 | 7.5 | 1 | 3.2 | 1.9503 | 6.1087 | 0.3979 | 0.4578 |
| Model 30 | 70 | 7.5 | 1 | 6.4 | 1.9503 | 6.1087 | 0.3979 | 0.9156 |
| Model 31 | 70 | 7.5 | 2 | 1.6 | 1.6514 | 16.238 | 0.87778 | 2.163 |
| Model 32 | 70 | 7.5 | 2 | 3.2 | 1.6514 | 16.238 | 0.87778 | 4.326 |
| Model 33 | 70 | 7.5 | 2 | 6.4 | 1.6514 | 16.238 | 0.87778 | 8.652 |
| Model 34 | 70 | 7.5 | 3 | 1.6 | 1.3529 | 21.061 | 1.2134 | 8.1663 |
| Model 35 | 70 | 7.5 | 3 | 3.2 | 1.3529 | 21.061 | 1.2134 | 16.3326 |
| Model 36 | 70 | 7.5 | 3 | 6.4 | 1.3529 | 21.061 | 1.2134 | 32.6652 |
| Model 37 | 70 | 15 | 1 | 1.6 | 4.2005 | 10.812 | 0.66654 | 0.36698 |
| Model 38 | 70 | 15 | 1 | 3.2 | 4.2005 | 10.812 | 0.66654 | 0.73396 |
| Model 39 | 70 | 15 | 1 | 6.4 | 4.2005 | 10.812 | 0.66654 | 1.46792 |
| Model 40 | 70 | 15 | 2 | 1.6 | 3.9028 | 21.456 | 1.3192 | 3.1677 |
| Model 41 | 70 | 15 | 2 | 3.2 | 3.9028 | 21.456 | 1.3192 | 6.3354 |
| Model 42 | 70 | 15 | 2 | 6.4 | 3.9028 | 21.456 | 1.3192 | 12.6708 |
| Model 43 | 70 | 15 | 3 | 1.6 | 3.6074 | 22.35 | 1.5256 | 10.635 |
| Model 44 | 70 | 15 | 3 | 3.2 | 3.6074 | 22.35 | 1.5256 | 21.27 |
| Model 45 | 70 | 15 | 3 | 6.4 | 3.6074 | 22.35 | 1.5256 | 42.54 |
| Model 46 | 70 | 30 | 1 | 1.6 | 8.7005 | 17.689 | 1.2039 | 0.56819 |
| Model 47 | 70 | 30 | 1 | 3.2 | 8.7005 | 17.689 | 1.2039 | 1.13638 |
| Model 48 | 70 | 30 | 1 | 6.4 | 8.7005 | 17.689 | 1.2039 | 2.27276 |
| Model 49 | 70 | 30 | 2 | 1.6 | 8.4052 | 22.556 | 1.7861 | 4.2519 |
| Model 50 | 70 | 30 | 2 | 3.2 | 8.4052 | 22.556 | 1.7861 | 8.5038 |
| Model 51 | 70 | 30 | 2 | 6.4 | 8.4052 | 22.556 | 1.7861 | 17.0076 |
| Model 52 | 70 | 30 | 3 | 1.6 | 8.1152 | 29.272 | 2.0998 | 12.822 |
| Model 53 | 70 | 30 | 3 | 3.2 | 8.1152 | 29.272 | 2.0998 | 25.644 |
| Model 54 | 70 | 30 | 3 | 6.4 | 8.1152 | 29.272 | 2.0998 | 51.288 |
| Model 55 | 140 | 7.5 | 1 | 1.6 | 1.9501 | 1.4916 | 0.11529 | 0.031022 |
| Model 56 | 140 | 7.5 | 1 | 3.2 | 1.9501 | 1.4916 | 0.11529 | 0.062044 |
| Model 57 | 140 | 7.5 | 1 | 6.4 | 1.9501 | 1.4916 | 0.11529 | 0.124088 |
| Model 58 | 140 | 7.5 | 2 | 1.6 | 1.5337 | 4.0111 | 0.23061 | 0.27123 |
| Model 59 | 140 | 7.5 | 2 | 3.2 | 1.5337 | 4.0111 | 0.23061 | 0.54246 |
| Model 60 | 140 | 7.5 | 2 | 6.4 | 1.5337 | 4.0111 | 0.23061 | 1.08492 |
| Model 61 | 140 | 7.5 | 3 | 1.6 | 1.3511 | 7.5477 | 0.41457 | 1.1831 |
| Model 62 | 140 | 7.5 | 3 | 3.2 | 1.3511 | 7.5477 | 0.41457 | 2.3662 |
| Model 63 | 140 | 7.5 | 3 | 6.4 | 1.3511 | 7.5477 | 0.41457 | 4.7324 |
| Model 64 | 140 | 15 | 1 | 1.6 | 4.2001 | 2.8176 | 0.20827 | 0.053511 |
| Model 65 | 140 | 15 | 1 | 3.2 | 4.2001 | 2.8176 | 0.20827 | 0.107022 |
| Model 66 | 140 | 15 | 1 | 6.4 | 4.2001 | 2.8176 | 0.20827 | 0.214044 |
| Model 67 | 140 | 15 | 2 | 1.6 | 3.9008 | 7.6317 | 0.41427 | 0.43851 |
| Model 68 | 140 | 15 | 2 | 3.2 | 3.9008 | 7.6317 | 0.41427 | 0.87702 |
| Model 69 | 140 | 15 | 2 | 6.4 | 3.9008 | 7.6317 | 0.41427 | 1.75404 |
| Model 70 | 140 | 15 | 3 | 1.6 | 3.6021 | 13.416 | 0.74683 | 1.6217 |
| Model 71 | 140 | 15 | 3 | 3.2 | 3.6021 | 13.416 | 0.74683 | 3.2434 |
| Model 72 | 140 | 15 | 3 | 6.4 | 3.6021 | 13.416 | 0.74683 | 6.4868 |
| Model 73 | 140 | 30 | 1 | 1.6 | 8.7001 | 4.803 | 0.32598 | 0.084092 |
| Model 74 | 140 | 30 | 1 | 3.2 | 8.7001 | 4.803 | 0.32598 | 0.168184 |
| Model 75 | 140 | 30 | 1 | 6.4 | 8.7001 | 4.803 | 0.32598 | 0.336368 |
| Model 76 | 140 | 30 | 2 | 1.6 | 8.4015 | 11.052 | 0.69915 | 0.69376 |
| Model 77 | 140 | 30 | 2 | 3.2 | 8.4015 | 11.052 | 0.69915 | 1.38752 |
| Model 78 | 140 | 30 | 2 | 6.4 | 8.4015 | 11.052 | 0.69915 | 2.77504 |
| Model 79 | 140 | 30 | 3 | 1.6 | 8.1041 | 20.652 | 1.2337 | 2.4826 |
| Model 80 | 140 | 30 | 3 | 3.2 | 8.1041 | 20.652 | 1.2337 | 4.9652 |
| Model 81 | 140 | 30 | 3 | 6.4 | 8.1041 | 20.652 | 1.2337 | 9.9304 |

| | Dimensions | | | | | | | |
|---|---|---|---|---|---|---|---|---|
| | Cell | Cell | Beam | Cell | 60% | | | |
| | Width | Height | Thickness | Depth | Deformation | Equivalent | Max Prin | Force |
| | (mm) | (mm) | (mm) | (mm) | [mm] | Stress [MPa] | Strain | Reaction [N] |
| Model 1 | 35 | 7.5 | 1 | 1.6 | 3.9018 | 24.042 | 1.7669 | 2.8984 |
| Model 2 | 35 | 7.5 | 1 | 3.2 | 3.9018 | 24.042 | 1.7669 | 5.7968 |
| Model 3 | 35 | 7.5 | 1 | 6.4 | 3.9018 | 24.042 | 1.7669 | 11.5936 |
| Model 4 | 35 | 7.5 | 2 | 1.6 | 3.3077 | 32.721 | 2.4364 | 19.307 |
| Model 5 | 35 | 7.5 | 2 | 3.2 | 3.3077 | 32.721 | 2.4364 | 38.614 |
| Model 6 | 35 | 7.5 | 2 | 6.4 | 3.3077 | 32.721 | 2.4364 | 77.228 |
| Model 7 | 35 | 7.5 | 3 | 1.6 | 2.7142 | 38.754 | 2.9692 | 57.181 |
| Model 8 | 35 | 7.5 | 3 | 3.2 | 2.7142 | 38.754 | 2.9692 | 114.362 |
| Model 9 | 35 | 7.5 | 3 | 6.4 | 2.7142 | 38.754 | 2.9692 | 228.724 |
| Model 10 | 35 | 15 | 1 | 1.6 | 8.4027 | 29.683 | 2.32 | 3.2965 |
| Model 11 | 35 | 15 | 1 | 3.2 | 8.4027 | 29.683 | 2.32 | 6.593 |
| Model 12 | 35 | 15 | 1 | 6.4 | 8.4027 | 29.683 | 2.32 | 13.186 |
| Model 13 | 35 | 15 | 2 | 1.6 | 7.816 | 40.718 | 3.0717 | 19.381 |
| Model 14 | 35 | 15 | 2 | 3.2 | 7.816 | 40.718 | 3.0717 | 38.762 |
| Model 15 | 35 | 15 | 2 | 6.4 | 7.816 | 40.718 | 3.0717 | 77.524 |
| Model 16 | 35 | 15 | 3 | 1.6 | 7.2471 | 45.068 | 3.4889 | 52.716 |
| Model 17 | 35 | 15 | 3 | 3.2 | 7.2471 | 45.068 | 3.4889 | 105.432 |
| Model 18 | 35 | 15 | 3 | 6.4 | 7.2471 | 45.068 | 3.4889 | 210.864 |
| Model 19 | 35 | 30 | 1 | 1.6 | 17.403 | 36.342 | 2.8324 | 3.0681 |
| Model 20 | 35 | 30 | 1 | 3.2 | 17.403 | 36.342 | 2.8324 | 6.1362 |
| Model 21 | 35 | 30 | 1 | 6.4 | 17.403 | 36.342 | 2.8324 | 12.2724 |
| Model 22 | 35 | 30 | 2 | 1.6 | 16.828 | 44.508 | 3.4493 | 15.707 |
| Model 23 | 35 | 30 | 2 | 3.2 | 16.828 | 44.508 | 3.4493 | 31.414 |
| Model 24 | 35 | 30 | 2 | 6.4 | 16.828 | 44.508 | 3.4493 | 62.828 |
| Model 25 | 35 | 30 | 3 | 1.6 | 16.289 | 50.037 | 3.8687 | 40.796 |
| Model 26 | 35 | 30 | 3 | 3.2 | 16.289 | 50.037 | 3.8687 | 81.592 |
| Model 27 | 35 | 30 | 3 | 6.4 | 16.289 | 50.037 | 3.8687 | 163.184 |
| Model 28 | 70 | 7.5 | 1 | 1.6 | 3.9006 | 12.152 | 0.79411 | 0.45614 |
| Model 29 | 70 | 7.5 | 1 | 3.2 | 3.9006 | 12.152 | 0.79411 | 0.91228 |
| Model 30 | 70 | 7.5 | 1 | 6.4 | 3.9006 | 12.152 | 0.79411 | 1.82456 |
| Model 31 | 70 | 7.5 | 2 | 1.6 | 3.3029 | 18.878 | 1.2674 | 4.2547 |
| Model 32 | 70 | 7.5 | 2 | 3.2 | 3.3029 | 18.878 | 1.2674 | 8.5094 |
| Model 33 | 70 | 7.5 | 2 | 6.4 | 3.3029 | 18.878 | 1.2674 | 17.0188 |
| Model 34 | 70 | 7.5 | 3 | 1.6 | 2.7067 | 23.635 | 1.6642 | 14.912 |
| Model 35 | 70 | 7.5 | 3 | 3.2 | 2.7067 | 23.635 | 1.6642 | 29.824 |
| Model 36 | 70 | 7.5 | 3 | 6.4 | 2.7067 | 23.635 | 1.6642 | 59.648 |
| Model 37 | 70 | 15 | 1 | 1.6 | 8.401 | 21.3 | 1.3197 | 0.70796 |
| Model 38 | 70 | 15 | 1 | 3.2 | 8.401 | 21.3 | 1.3197 | 1.41592 |
| Model 39 | 70 | 15 | 1 | 6.4 | 8.401 | 21.3 | 1.3197 | 2.83184 |
| Model 40 | 70 | 15 | 2 | 1.6 | 7.8058 | 23.871 | 1.745 | 5.3728 |
| Model 41 | 70 | 15 | 2 | 3.2 | 7.8058 | 23.871 | 1.745 | 10.7456 |
| Model 42 | 70 | 15 | 2 | 6.4 | 7.8058 | 23.871 | 1.745 | 21.4912 |
| Model 43 | 70 | 15 | 3 | 1.6 | 7.2155 | 32.24 | 2.251 | 16.502 |
| Model 44 | 70 | 15 | 3 | 3.2 | 7.2155 | 32.24 | 2.251 | 33.004 |
| Model 45 | 70 | 15 | 3 | 6.4 | 7.2155 | 32.24 | 2.251 | 66.008 |
| Model 46 | 70 | 30 | 1 | 1.6 | 17.401 | 22.302 | 1.5805 | 0.99902 |
| Model 47 | 70 | 30 | 1 | 3.2 | 17.401 | 22.302 | 1.5805 | 1.99804 |
| Model 48 | 70 | 30 | 1 | 6.4 | 17.401 | 22.302 | 1.5805 | 3.99608 |
| Model 49 | 70 | 30 | 2 | 1.6 | 16.809 | 32.78 | 2.3596 | 6.2466 |
| Model 50 | 70 | 30 | 2 | 3.2 | 16.809 | 32.78 | 2.3596 | 12.4932 |
| Model 51 | 70 | 30 | 2 | 6.4 | 16.809 | 32.78 | 2.3596 | 24.9864 |
| Model 52 | 70 | 30 | 3 | 1.6 | 16.23 | 39.407 | 2.8827 | 17.798 |
| Model 53 | 70 | 30 | 3 | 3.2 | 16.23 | 39.407 | 2.8827 | 35.596 |
| Model 54 | 70 | 30 | 3 | 6.4 | 16.23 | 39.407 | 2.8827 | 71.192 |
| Model 55 | 140 | 7.5 | 1 | 1.6 | 3.9002 | 2.9829 | 0.23054 | 0.62768 |
| Model 56 | 140 | 7.5 | 1 | 3.2 | 3.9002 | 2.9829 | 0.23054 | 1.25536 |
| Model 57 | 140 | 7.5 | 1 | 6.4 | 3.9002 | 2.9829 | 0.23054 | 2.51072 |
| Model 58 | 140 | 7.5 | 2 | 1.6 | 3.0675 | 8.0079 | 0.4604 | 0.54214 |
| Model 59 | 140 | 7.5 | 2 | 3.2 | 3.0675 | 8.0079 | 0.4604 | 1.08428 |
| Model 60 | 140 | 7.5 | 2 | 6.4 | 3.0675 | 8.0079 | 0.4604 | 2.16856 |
| Model 61 | 140 | 7.5 | 3 | 1.6 | 2.7022 | 15.059 | 0.82693 | 2.3624 |
| Model 62 | 140 | 7.5 | 3 | 3.2 | 2.7022 | 15.059 | 0.82693 | 4.7248 |
| Model 63 | 140 | 7.5 | 3 | 6.4 | 2.7022 | 15.059 | 0.82693 | 9.4496 |
| Model 64 | 140 | 15 | 1 | 1.6 | 8.4003 | 5.6129 | 0.41589 | 0.095157 |
| Model 65 | 140 | 15 | 1 | 3.2 | 8.4003 | 5.6129 | 0.41589 | 0.190314 |
| Model 66 | 140 | 15 | 1 | 6.4 | 8.4003 | 5.6129 | 0.41589 | 0.380628 |
| Model 67 | 140 | 15 | 2 | 1.6 | 7.8016 | 15.189 | 0.82398 | 0.86038 |
| Model 68 | 140 | 15 | 2 | 3.2 | 7.8016 | 15.189 | 0.82398 | 1.72076 |
| Model 69 | 140 | 15 | 2 | 6.4 | 7.8016 | 15.189 | 0.82398 | 3.44152 |
| Model 70 | 140 | 15 | 3 | 1.6 | 7.2042 | 20.864 | 1.2571 | 3.2102 |
| Model 71 | 140 | 15 | 3 | 3.2 | 7.2042 | 20.864 | 1.2571 | 6.4204 |
| Model 72 | 140 | 15 | 3 | 6.4 | 7.2042 | 20.864 | 1.2571 | 12.8408 |
| Model 73 | 140 | 30 | 1 | 1.6 | 17.4 | 9.4854 | 0.64604 | 0.18939 |
| Model 74 | 140 | 30 | 1 | 3.2 | 17.4 | 9.4854 | 0.64604 | 0.37878 |
| Model 75 | 140 | 30 | 1 | 6.4 | 17.4 | 9.4854 | 0.64604 | 0.75756 |
| Model 76 | 140 | 30 | 2 | 1.6 | 16.803 | 20.947 | 1.3824 | 1.3838 |
| Model 77 | 140 | 30 | 2 | 3.2 | 16.803 | 20.947 | 1.3824 | 2.7676 |
| Model 78 | 140 | 30 | 2 | 6.4 | 16.803 | 20.947 | 1.3824 | 5.5352 |
| Model 79 | 140 | 30 | 3 | 1.6 | 16.209 | 21.569 | 1.5226 | 4.6203 |
| Model 80 | 140 | 30 | 3 | 3.2 | 16.209 | 21.569 | 1.5226 | 9.2406 |
| Model 81 | 140 | 30 | 3 | 6.4 | 16.209 | 21.569 | 1.5226 | 18.4812 |

| | Dimensions | | | | | | | |
|---|---|---|---|---|---|---|---|---|
| | Cell | Cell | Beam | Cell | 90% | | | |
| | Width | Height | Thickness | Depth | Deformation | Equivalent | Max Prin | Force |
| | (mm) | (mm) | (mm) | (mm) | [mm] | Stress [MPa] | Strain | Reaction [N] |
| Model 1 | 35 | 7.5 | 1 | 1.6 | 5.8525 | 28.247 | 2.2013 | 3.6759 |
| Model 2 | 35 | 7.5 | 1 | 3.2 | 5.8526 | 28.315 | 2.2046 | 7.3518 |
| Model 3 | 35 | 7.5 | 1 | 6.4 | 5.8527 | 28.289 | 2.2047 | 14.7036 |
| Model 4 | 35 | 7.5 | 2 | 1.6 | 4.9608 | 38.757 | 2.9103 | 23.516 |
| Model 5 | 35 | 7.5 | 2 | 3.2 | 4.9608 | 38.757 | 2.9103 | 47.032 |
| Model 6 | 35 | 7.5 | 2 | 6.4 | 4.9608 | 38.757 | 2.9103 | 94.064 |
| Model 7 | 35 | 7.5 | 3 | 1.6 | 4.0739 | 43.257 | 3.3229 | 68.479 |
| Model 8 | 35 | 7.5 | 3 | 3.2 | 4.0739 | 43.257 | 3.3229 | 136.958 |
| Model 9 | 35 | 7.5 | 3 | 6.4 | 4.0739 | 43.257 | 3.3229 | 273.916 |
| Model 10 | 35 | 15 | 1 | 1.6 | 12.603 | 35.877 | 2.761 | 3.9969 |
| Model 11 | 35 | 15 | 1 | 3.2 | 12.603 | 35.877 | 2.761 | 7.9938 |
| Model 12 | 35 | 15 | 1 | 6.4 | 12.603 | 35.877 | 2.761 | 15.9876 |
| Model 13 | 35 | 15 | 2 | 1.6 | 11.72 | 44.962 | 3.4077 | 21.905 |
| Model 14 | 35 | 15 | 2 | 3.2 | 11.72 | 44.962 | 3.4077 | 43.81 |
| Model 15 | 35 | 15 | 2 | 6.4 | 11.72 | 44.962 | 3.4077 | 87.62 |
| Model 16 | 35 | 15 | 3 | 1.6 | 10.865 | 48.549 | 3.7396 | 57.303 |
| Model 17 | 35 | 15 | 3 | 3.2 | 10.865 | 48.549 | 3.7396 | 114.606 |
| Model 18 | 35 | 15 | 3 | 6.4 | 10.865 | 48.549 | 3.7396 | 229.212 |
| Model 19 | 35 | 30 | 1 | 1.6 | 26.104 | 41.788 | 3.2343 | 3.5063 |
| Model 20 | 35 | 30 | 1 | 3.2 | 26.104 | 41.788 | 3.2343 | 7.0126 |
| Model 21 | 35 | 30 | 1 | 6.4 | 26.104 | 41.788 | 3.2343 | 14.0252 |
| Model 22 | 35 | 30 | 2 | 1.6 | 25.23 | 48.363 | 3.7372 | 16.673 |
| Model 23 | 35 | 30 | 2 | 3.2 | 25.23 | 48.363 | 3.7372 | 33.346 |
| Model 24 | 35 | 30 | 2 | 6.4 | 25.23 | 48.363 | 3.7372 | 66.692 |
| Model 25 | 35 | 30 | 3 | 1.6 | 24.41 | 51.64 | 3.9883 | 41.104 |
| Model 26 | 35 | 30 | 3 | 3.2 | 24.41 | 51.64 | 3.9883 | 82.208 |
| Model 27 | 35 | 30 | 3 | 6.4 | 24.41 | 51.64 | 3.9883 | 164.416 |
| Model 28 | 70 | 7.5 | 1 | 1.6 | 5.8509 | 18.149 | 1.1898 | 0.68371 |
| Model 29 | 70 | 7.5 | 1 | 3.2 | 5.8509 | 18.149 | 1.1898 | 1.36742 |
| Model 30 | 70 | 7.5 | 1 | 6.4 | 5.8509 | 18.149 | 1.1898 | 2.73484 |
| Model 31 | 70 | 7.5 | 2 | 1.6 | 4.9547 | 21.965 | 1.5698 | 5.8345 |
| Model 32 | 70 | 7.5 | 2 | 3.2 | 4.9547 | 21.965 | 1.5698 | 11.669 |
| Model 33 | 70 | 7.5 | 2 | 6.4 | 4.9547 | 21.965 | 1.5698 | 23.338 |
| Model 34 | 70 | 7.5 | 3 | 1.6 | 4.0605 | 29.368 | 2.0335 | 19.513 |
| Model 35 | 70 | 7.5 | 3 | 3.2 | 4.0605 | 29.368 | 2.0335 | 39.026 |
| Model 36 | 70 | 7.5 | 3 | 6.4 | 4.0605 | 29.368 | 2.0335 | 78.052 |
| Model 37 | 70 | 15 | 1 | 1.6 | 12.601 | 22.692 | 1.4227 | 1.0107 |
| Model 38 | 70 | 15 | 1 | 3.2 | 12.601 | 22.692 | 1.4227 | 2.0214 |
| Model 39 | 70 | 15 | 1 | 6.4 | 12.601 | 22.692 | 1.4227 | 4.0428 |
| Model 40 | 70 | 15 | 2 | 1.6 | 11.708 | 30.076 | 2.2013 | 6.8552 |
| Model 41 | 70 | 15 | 2 | 3.2 | 11.708 | 30.076 | 2.2013 | 13.7104 |
| Model 42 | 70 | 15 | 2 | 6.4 | 11.708 | 30.076 | 2.2013 | 27.4208 |
| Model 43 | 70 | 15 | 3 | 1.6 | 10.824 | 37.786 | 2.7341 | 20.487 |
| Model 44 | 70 | 15 | 3 | 3.2 | 10.824 | 37.786 | 2.7341 | 40.974 |
| Model 45 | 70 | 15 | 3 | 6.4 | 10.824 | 37.786 | 2.7341 | 81.948 |
| Model 46 | 70 | 30 | 1 | 1.6 | 26.101 | 26.833 | 1.973 | 1.2838 |
| Model 47 | 70 | 30 | 1 | 3.2 | 26.101 | 26.833 | 1.973 | 2.5676 |
| Model 48 | 70 | 30 | 1 | 6.4 | 26.101 | 26.833 | 1.973 | 5.1352 |
| Model 49 | 70 | 30 | 2 | 1.6 | 25.212 | 38.654 | 2.8513 | 7.5594 |
| Model 50 | 70 | 30 | 2 | 3.2 | 25.212 | 38.654 | 2.8513 | 15.1188 |
| Model 51 | 70 | 30 | 2 | 6.4 | 25.212 | 38.654 | 2.8513 | 30.2376 |
| Model 52 | 70 | 30 | 3 | 1.6 | 24.34 | 42.272 | 3.2392 | 24.893 |
| Model 53 | 70 | 30 | 3 | 3.2 | 24.34 | 42.272 | 3.2392 | 49.786 |
| Model 54 | 70 | 30 | 3 | 6.4 | 24.34 | 42.272 | 3.2392 | 99.572 |
| Model 55 | 140 | 7.5 | 1 | 1.6 | 5.8503 | 4.4751 | 0.34585 | 0.95493 |
| Model 56 | 140 | 7.5 | 1 | 3.2 | 5.8503 | 4.4751 | 0.34585 | 1.90986 |
| Model 57 | 140 | 7.5 | 1 | 6.4 | 5.8503 | 4.4751 | 0.34585 | 3.81972 |
| Model 58 | 140 | 7.5 | 2 | 1.6 | 4.6012 | 11.993 | 0.68951 | 0.81335 |
| Model 59 | 140 | 7.5 | 2 | 3.2 | 4.6012 | 11.993 | 0.68951 | 1.6267 |
| Model 60 | 140 | 7.5 | 2 | 6.4 | 4.6012 | 11.993 | 0.68951 | 3.2534 |
| Model 61 | 140 | 7.5 | 3 | 1.6 | 4.0533 | 22.539 | 1.2373 | 3.54 |
| Model 62 | 140 | 7.5 | 3 | 3.2 | 4.0533 | 22.539 | 1.2373 | 7.08 |
| Model 63 | 140 | 7.5 | 3 | 6.4 | 4.0533 | 22.539 | 1.2373 | 14.16 |
| Model 64 | 140 | 15 | 1 | 1.6 | 12.6 | 8.3942 | 0.62353 | 0.15438 |
| Model 65 | 140 | 15 | 1 | 3.2 | 12.6 | 8.3942 | 0.62353 | 0.30876 |
| Model 66 | 140 | 15 | 1 | 6.4 | 12.6 | 8.3942 | 0.62353 | 0.61752 |
| Model 67 | 140 | 15 | 2 | 1.6 | 11.702 | 22.696 | 1.2304 | 1.2987 |
| Model 68 | 140 | 15 | 2 | 3.2 | 11.702 | 22.696 | 1.2304 | 2.5974 |
| Model 69 | 140 | 15 | 2 | 6.4 | 11.702 | 22.696 | 1.2304 | 5.1948 |
| Model 70 | 140 | 15 | 3 | 1.6 | 10.807 | 19.929 | 1.378 | 4.6851 |
| Model 71 | 140 | 15 | 3 | 3.2 | 10.807 | 19.929 | 1.378 | 9.3702 |
| Model 72 | 140 | 15 | 3 | 6.4 | 10.807 | 19.929 | 1.378 | 18.7404 |
| Model 73 | 140 | 30 | 1 | 1.6 | 26.1 | 14.107 | 0.96395 | 0.29546 |
| Model 74 | 140 | 30 | 1 | 3.2 | 26.1 | 14.107 | 0.96395 | 0.59092 |
| Model 75 | 140 | 30 | 1 | 6.4 | 26.1 | 14.107 | 0.96395 | 1.18184 |
| Model 76 | 140 | 30 | 2 | 1.6 | 25.204 | 22.324 | 1.4647 | 1.9638 |
| Model 77 | 140 | 30 | 2 | 3.2 | 25.204 | 22.324 | 1.4647 | 3.9276 |
| Model 78 | 140 | 30 | 2 | 6.4 | 25.204 | 22.324 | 1.4647 | 7.8552 |
| Model 79 | 140 | 30 | 3 | 1.6 | 24.311 | 28.669 | 2.0436 | 8.7831 |
| Model 80 | 140 | 30 | 3 | 3.2 | 24.311 | 28.669 | 2.0436 | 17.5662 |
| Model 81 | 140 | 30 | 3 | 6.4 | 24.311 | 28.669 | 2.0436 | 35.1324 |

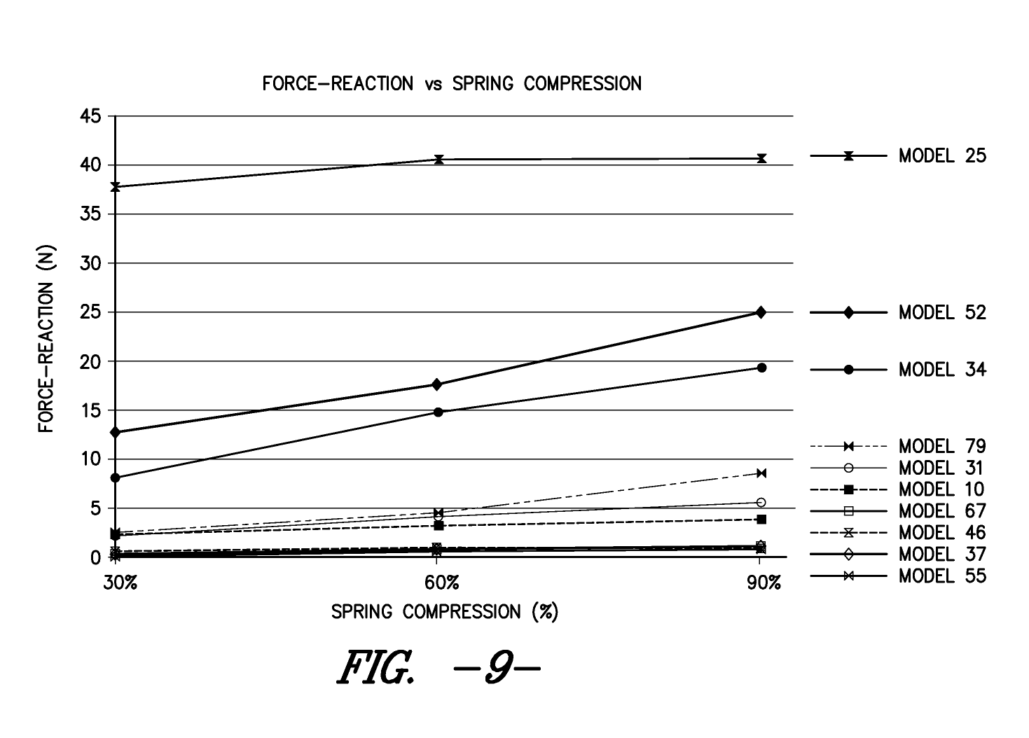

As described above, the computer simulation can output equivalent stress, maximum principal strain, and reaction force. The equivalent stress, maximum principal strain, and reaction force for model numbers 10, 25, 31, 34, 37, 46, 52, 55, 67, and 79 are illustrated in FIGS. 7 through 9 respectively.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A polymer spring comprising:
a metal-free spring member made from a polymer material, the spring member comprising a network of interconnected closed cells, the cells being arranged in the network in columns that are configured to receive a compressive force, the cells being formed from rows of wave-like structural members, the wave-like structural members including valleys and peaks in an alternating arrangement, the wave-like structural members being interconnected such that the peaks of one row are connected to the valleys of an adjacent row in a manner such that one column of cells is offset and nested with an adjacent column of cells, the polymer material having an elastic modulus of from about 800 MPa to about 1500 MPa.

2. A polymer spring as defined in claim 1, wherein the polymer material comprises a polyoxymethylene polymer.

3. A polymer spring as defined in claim 1, wherein the polymer material comprises a polyamide; polyphthalamide; thermoplastic ether-ester elastomer; thermoplastic polyether-ester elastomer; polybutylene terephthalate; polybutylene terephthalate alloys; cellulose acetate butyrate; cellulose acetate proprionate; thermoplastic vulcanizates; thermoplastic polyurethane elastomers including polyester-based and polyether-based elastomers; polymethyl methacrylate; polyurethane; acrylonitrile ethylene styrene; styrene butadiene styrene block copolymer; polymer alloys containing polyester based thermoplastic polyurethane elastomer polymers; polymer alloys containing acrylonitrile-butadiene styrene terpolymer and polyamide polymers; polymer alloys containing polyphenylene ether, polystyrene, and polypropylene polymers; polymer alloys containing polyphenylene ether, polystyrene, and nylon polymers; polymer alloys containing polyphenylene ether and polystyrene polymers; polymer alloys containing acrylonitrile styrene acrylate and polyamide polymers; polymer alloys containing polypropylene and ethylene propylene diene monomer rubber polymers; polymer alloys containing polyamide and polypropylene polymers; polymer alloys containing polyethylene terephthalate and polyamide polymers.

4. A polymer spring as defined in claim 1, wherein the individual cells have a height and a width, the height to width ratio of each cell being from about 1:3 to about 1:20.

5. A polymer spring as defined in claim 1, wherein the individual cells have a height and a width, the height to width ratio of each cell being from about 1:4 to about 1:10.

6. A cushion having a top and a bottom, the cushion having a plurality of polymer springs as defined in claim 1 that are spaced apart from each other and are positioned within the cushion, the columns of cells within each polymer spring extending in a direction from the bottom to the top of the cushion.

7. A polymer spring as defined in claim 1, wherein the polymer spring has a force displacement curve at 200 mm/min such that the spring deflects from about 40 mm to about 20 mm at a load of 700 N.

8. A polymer spring as defined in claim 1, wherein the polymer spring has a force displacement curve at 200 mm/min such that the spring deflects from about 35 mm to about 25 mm at a load of 700 N.

9. A polymer spring as defined in claim 1, wherein each individual cell has a curvilinear shape or an elliptical shape.

10. A polymer spring as defined in claim 1, wherein the structural members of the polymer spring have a thickness of from about 2 mm to about 5 mm.

11. A polymer spring as defined in claim 1, wherein each column of cells contains from about 2 to about 5 cells.

12. A polymer spring as defined in claim 1, wherein the spring exhibits a strain of no greater than about 2.5% strain when under full compression.

13. A polymer spring as defined in claim 1, wherein the polymer material has a tensile modulus of greater than about 800 MPa, has a tensile stress at yield of greater than about 20 MPa, has a tensile strain at yield of greater than about 15%, has a Charpy notched impact strength at −30° C. of greater than about 10 kJ/m², and has a DTUL at 1.8 MPa of greater than about 50° C., the polymer material having a level of crystallinity of at least about 70%.

14. A method of designing a polymer spring, the polymer spring including a plurality of closed cells that are configured to receive a compressive force, the method comprising:
selecting a polymer material to form the spring, the polymer material having a true stress verses strain curve;
converting the true stress verses strain curve for the polymer material into a true stress verses plastic strain curve;
inputting data regarding the true stress verses plastic strain curve into a computer simulation of the polymer spring, the computer simulation being configured to generate a force displacement curve based on inputted cell dimensions and an inputted deflection distance;
adjusting at least one cell dimension within the computer simulation until a desired force displacement result is obtained; and
constructing a polymer spring based on the resulting cell dimensions.

15. A method as defined in claim 14, wherein the polymer material has an engineering stress verses engineering strain curve and wherein the method further includes the step of converting the engineering stress verses engineering strain curve to the true stress verses true strain curve.

16. A method as defined in claim 14, further comprising a step of inputting a tensile modulus of the polymer material into the computer simulation.

17. A method as defined in claim 14, wherein, after converting the true stress verses true strain curve into a true stress verses plastic strain curve, the true stress verses plastic strain curve is normalized such that the curve is a zero at initial plastic strain.

18. A method as defined in claim 13, wherein the computer simulation is of a single cell.

19. A method as defined in claim 14, wherein the computer simulation is of a column of cells.

20. A method as defined in claim 14, wherein the closed cells of the polymer spring form an interconnected network, the cells being arranged in the network in columns that are configured to receive the compressive force, the cells being formed from rows of wave-like structural members, the wave-like structural members including valleys and peaks in an alternating arrangement, the wave-like structural members being interconnected such that the peaks of one row are connected to the valleys of an adjacent row in a manner such that one column of cells is offset and nested with an adjacent column of cells.

21. A method as defined in claim 14, wherein the polymer material comprises a polyoxymethylene polymer.

22. A method as defined in claim 14, wherein the polymer material comprises a polyamide; polyphthalamide; thermoplastic ether-ester elastomer; thermoplastic polyether-ester elastomer; polybutylene terephthalate; polybutylene terephthalate alloys; cellulose acetate butyrate; cellulose acetate proprionate; thermoplastic vulcanizates; thermoplastic polyurethane elastomers including polyester-based and polyether-based elastomers; polymethyl methacrylate; polyurethane; acrylonitrile ethylene styrene; styrene butadiene styrene block copolymer; polymer alloys containing polyester based thermoplastic polyurethane elastomer polymers; polymer alloys containing acrylonitrile-butadiene styrene terpolymer and polyamide polymers; polymer alloys containing polyphenylene ether, polystyrene, and polypropylene polymers; polymer alloys containing polyphenylene ether, polystyrene, and nylon polymers; polymer alloys containing polyphenylene ether and polystyrene polymers; polymer alloys containing acrylonitrile styrene acrylate and polyamide polymers; polymer alloys containing polypropylene and ethylene propylene diene monomer rubber polymers; polymer alloys containing polyamide and polypropylene polymers; polymer alloys containing polyethylene terephthalate and polyamide polymers.

23. A method as defined in claim 14, wherein the polymer spring comprises a flat spring.

24. A method as defined in claim 14, wherein the computer simulation is configured to determine a force at from about 2 to about 5 points over the inputted deflection distance.

25. A method as defined in claim 14, wherein the computer simulation, in addition to generating a force displacement curve, determines equivalent stress and maximum strain.

26. A method as defined in claim 14, wherein the desired force displacement result is based on a force displacement curve of a metal spring that is being replaced by the polymer spring.

27. A method as defined in claim 26, further comprising the step of comparing the force displacement result obtained from the computer simulation with a force displacement curve of the metal spring and determining whether further adjustments to at least one cell dimension are needed based upon the comparison.

28. A method as defined in claim 14, wherein the polymer material has a tensile modulus of greater than about 800 MPa, has a tensile stress at yield of greater than about 20 MPa, has a tensile strain at yield of greater than about 15%, has a Charpy notched impact strength at −30° C. of greater than about 10 kJ/m², and has a DTUL at 1.8 MPa of greater than about 50° C., the polymer material having a level of crystallinity of at least about 70%.
